(19) United States
(12) Patent Application Publication
(10) Pub. No.: US 2004/0072549 A1
(43) Pub. Date: Apr. 15, 2004

(54) Communication device with front-end antenna and filter integration

(76) Inventor: John Richard Sanford, Encinitas, CA (US)

Correspondence Address: JERRY H. MACHADO, 1142 MOORE ROAD, WOODSIDE, CA, 94062-1112, US

(21) Appl. No.: 10/268,563

(22) Filed: Oct. 10, 2002

(51) Int. Cl. H04B 1/18; H04B 1/06

(52) U.S. Cl. 455/290; 455/275; 455/307

(57) ABSTRACT

Integrated RF components in the radio frequency (RF) front end of a communication device. The RF front end includes an antenna function for converting between radiated and electronic signals, includes a filter function for limiting signals within operating frequency bands, an amplifier function for boosting signal power and a mixer function for shifting frequencies between RF and lower frequencies. The receive antenna function is separate from the transmit antenna function where a common integrated filter/antenna (filtenna) is employed for both the receive path and the transmit path.

### BACKGROUND OF THE INVENTION

The present invention relates to the field of communication devices that communicate using radiation of electromagnetic energy and particularly relates to antennas and radio frequency (RF) front ends for such communication devices, particularly for small communication devices carried by persons or communication devices otherwise benefitting from small-sized antennas and small-sized front ends.

Small communication devices include front-end components connected to base-band components (base components). The front-end components operate at RF frequencies and the base components operate at intermediate frequencies (IF) or other frequencies lower than RF frequencies. The RF front-end components for small devices have proved to be difficult to design, difficult to miniaturize and have added significant costs to small communication devices.

Communication devices that both transmit and receive with different transmit and receive bands typically use filters (duplexers, diplexers) to isolate the transmit and receive bands. Such communication devices typically employ broadband antennas that operate over frequency bands that are wider than the operating bands of interest and therefore the filters used to separate the receive (Rx) band and the transmit (Tx) band of a communication device operate to constrain the bandwidth within the desired operating receive (Rx) and the transmit (Tx) frequency bands. A communication device using transmit and receive bands for two-way communication is often referred to as a “single-band” communication device since the transmit and receive bands are usually close to each other within the frequency spectrum and are paired or otherwise related to each other for a common transmit/receive protocol. Dual-band communication devices use two pairs of transmit and receive bands, each pair for two-way communication. In multi-band communication devices, multiple pairs of transmit and receive bands are employed, each pair for two-way communication. In dual-band and other multi-band communication devices, additional filters are needed to separate the multiple bands and in addition, filters are also required to separate transmit and receive signals within each of the multiple bands. In standard designs, a Low Noise Amplifier (LNA) is included between the antenna and a mixer. The mixer converts between RF frequencies of the front-end components and lower frequencies of the base components.

Communication Antennas Generally. In communication devices and other electronic devices, antennas are elements having the primary function of transferring energy to (in the receive mode) or from (in the transmit mode) the electronic device through radiation. Energy is transferred from the electronic device (in the transmit mode) into space or is transferred (in the receive mode) from space into the electronic device. A transmitting antenna is a structure that forms a transition between guided waves contained within the electronic device and space waves traveling in space external to the electronic device. The receiving antenna forms a transition between space waves traveling external to the electronic device and guided waves contained within the electronic device. Often the same antenna operates both to receive and transmit radiation energy.

Frequencies at which antennas radiate are resonant frequencies for the antenna. A resonant frequency, f of an antenna can have many different values as a function, for example, of dielectric constant of material surrounding an antenna, the type of antenna, the geometry of the antenna and the speed of light.

In general, wave-length, λ, is given by λ=c/f=cT where c=velocity of light (=3×10⁸ meters/sec), f=frequency (cycles/sec), T=1/f=period (sec). Typically, the antenna dimensions such as antenna length, Aₗ, relate to the radiation wavelength λ of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rᵣ, of the antenna decreases sharply when the antenna length is shortened. Small loops and short dipoles typically are resonant at lengths of ½λ and ¼λ, respectively. Ohmic losses due to the ohmic resistance, Rₒ are minimized using impedance matching networks. Although impedance matched small loop antennas can exhibit 50% to 85% efficiencies, their bandwidths have been narrow, with very high Q, for example, Q>50. Q is often defined as (transmitted or received frequency)/(3 dB bandwidth).

An antenna radiates when the impedance of the antenna approaches being purely resistive (the reactive component approaches 0). Impedance is a complex number consisting of real resistance and imaginary reactance components. A matching network can be used to force resonance by eliminating reactive components of impedance for particular frequencies.

The RF front end of a communication device that operates to both transmit and receive signals includes antenna, filter, amplifier and mixer components that have a receiver path and a transmitter path. The receiver path operates to receive the radiation through the antenna. The antenna is matched at its output port to a standard impedance such as 50 ohms. The antenna captures the radiation signal from the air and transfers it as an electronic signal to a transmission line at the antennas output port. The electronic signal from the antenna enters the filter which has an input port that has also been matched to the standard impedance. The function of the filter is to remove unwanted interference and separate the receive signal from the transmit signal. The filter typically has an output port matched to the standard impedance. After the filter, the receive signal travels to a low noise amplifier (LNA) which similarly has input and output ports matched to the standard impedance, 50 ohms in the assumed example. The LNA boosts the signal to a level large enough so that other energy leaking into the transmission line will not significantly distort the receive signal. After the LNA, the receive signal is filtered with a high performance filter which has input and output ports matched to the standard impedance. After the high performance filter, the receive signal is converted to a lower frequency (intermediate frequency, IF) by a mixer which typically has an input port matched to the standard impedance.

The transmit path is much the same as the receive path. The lower frequency transmission signal from the base components is converted to an RF signal in the mixer and leaves the mixer which has a standard impedance output (for example, 50 ohms in the present example). The transmission signal from the mixer is “cleaned up” by a high performance filter which similarly has input and output ports matched to the standard impedance. The transmission signal is then buffered in a buffer amplifier and amplified in a power amplifier where the amplifiers are connected together with standard impedance lines, 50 ohms in the present example. The transmission signal is then connected to a filter, with input and output ports matched to the standard impedance. The filter functions to remove the remnant noise introduced by the receive signal. The filter output is matched to the standard impedance and connects to the antenna which has an input impedance matched to the standard impedance.

As described above, the antenna, filter, amplifier and mixer components that form the RF front end of a small communication device each have ports that are connected together from component port to component port to form a transmission path and a receive path. Each port of a component is sometimes called a junction. For a standard design, the junction properties of each component in the transmission path and in the receive path are matched to standard parameters at each junction, and specifically are matched to a standard junction impedance such as 50 ohms. In addition to impedance values, each junction is also definable by additional parameters including scattering matrix values and transmittance matrix values. The junction impedance values, scattering matrix values and transmittance matrix values are mathematically related so that measurement or other determination of one value allows the calculation of the others.

Typical front-end designs place constraints upon the physical junctions of each component and treat each component as a discrete entity which is designed in many respects independently of the designs of other components provided that the standard matching junction parameter values are maintained. While the discrete nature of components with standard junction parameters tends to simplify the design process, the design of each junction to satisfy standard parameter values (for example, 50 ohms junction impedance) places unwanted limitations upon the overall front-end design.

In consideration of the above background, there is a need for improved antennas and front ends suitable for communication devices and other devices needing small and compact RF front ends.

### SUMMARY

The present invention is for integrated RF components in the radio frequency (RF) front end of a communication device. The RF front end includes an antenna function for converting between radiated and electronic signals, include a filter function for limiting signals within operating frequency bands, an amplifier function for boosting signal power and a mixer function for shifting frequencies between RF and lower frequencies.

The integrated RF components combine the antenna function and filter function into a filter/antenna (filtenna) integrated component. The integrated component includes junction parameters for the combined antenna and filter functions without need for standardizing junction parameters for any physical port between the antenna and filter functions. A degree of freedom is added to the design of the integrated components (filtennas) whereby, for example, a pole in the antenna is combined with poles in the filter to enhance the filter function. In this manner, the antenna function provides a resonator that combines with resonators of the filter function to enhance the filtering.

In one embodiment, RF components perform the RF front-end functions and have both a receive path and a transmit path. The receive path and transmit paths include antenna, filter, amplifier and mixer functions. The RF front-end functions are connected by junctions where the junction between the antenna function and the filter functions are integrated so that the combined antenna and filter functions are tuned but the internal junction parameters are integrated and hence not separately tuned. In particular, the junction impedance or other parameters which may exist at the antenna are not tuned to provide standard values, such as a 50 ohm matching impedance.

In another embodiment, a multi-band small communication device has base components and RF front-end components that include antenna, filter, amplifier and mixer functions for each band. In one embodiment, a single multiport filtenna is employed. The filtenna integrates the antenna function and the filter function for each band so that the internal antenna and filter junction parameters are integrated and not separately considered. In another embodiment, a plurality of filtennas, one for each of the bands of the multi-band device are employed.

The foregoing and other objects, features and advantages of the invention will be apparent from the following detailed description in conjunction with the drawings.

### BRIEF DESCRIPTION OF THE DRAWINGS

FIG. 1 depicts a schematic view of a small communication device with RF front-end functions including an integrated antenna/filter functions and lower frequency base components.

FIG. 2 depicts a schematic representation of a typical junction in the RF front end of the communication device of FIG. 1.

FIG. 3 depicts a schematic representation of the connection of K junctions in the RF front end of a device such as the communication device of FIG. 1.

FIG. 4 depicts a schematic view of a small communication device with RF front-end functions including integrated antenna/filter functions for both transmit and receive paths and including lower frequency base components.

FIG. 5 depicts a representation of a front view of a cellular phone representative of the small communication devices of the present application.

FIG. 6 depicts a representation of an end view of the cellular phone of FIG. 5.

FIG. 7 depicts a schematic view of a dual-band small communication device with RF front-end functions including integrated antenna/filter functions for both transmit and receive paths in both bands and including lower frequency base components.

FIG. 8 depicts a schematic view of a multi-band small communication device with RF front-end functions including integrated antenna/filter functions for transmit and receive paths in all bands and including lower frequency base components.

FIG. 9 depicts a schematic view of a multi-band small communication device with RF front-end functions including separate integrated antenna/filter functions for transmit and receive paths in each band and including lower frequency base components.

### DETAILED DESCRIPTION

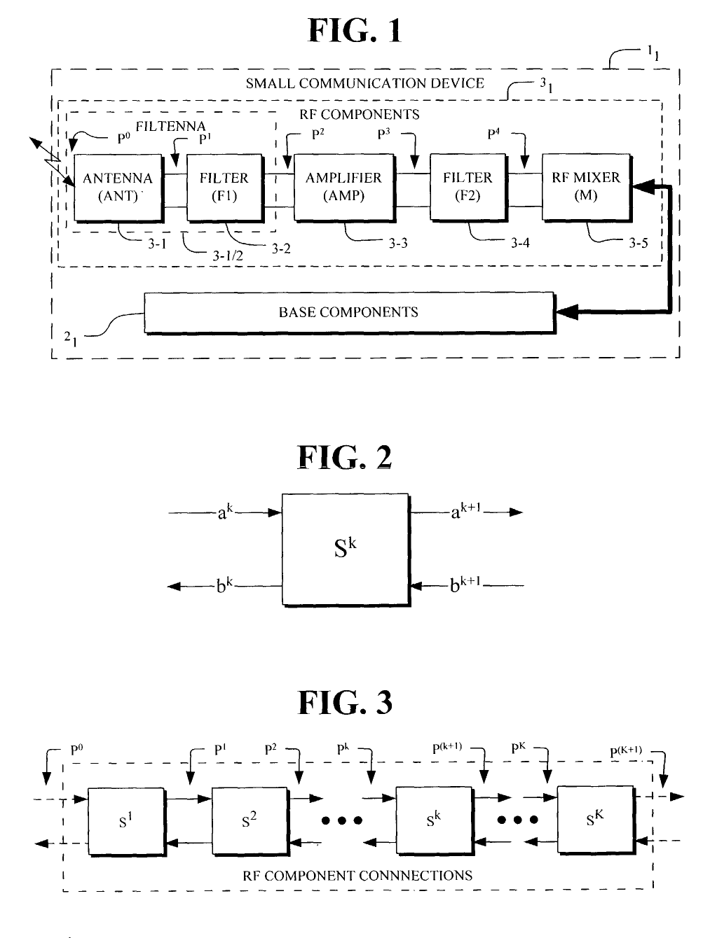

FIG. 1 depicts a schematic view of a small communication device 1₁ with RF front-end components 3₁ and base components 2₁. The RF components 3₁ perform the RF front-end functions that include an antenna function 3-1, a filter function 3-2, an amplifier function 3-3, a filter function 3-4 and a mixer function 3-5. The antenna function 3-1 is for converting between radiated and electronic signals, the filter function 3-2 is for limiting signals within operating frequency bands, the amplifier function 3-3 is for boosting signal power, the filter function 3-4 is for limiting signals within operating frequency bands, and the mixer function 3-5 is for shifting frequencies between RF and lower frequencies. The base components 2₁ perform lower frequency functions including intermediate-band and base-band processing necessary or useful for the communication device operation.

In FIG. 1, the RF front-end functions are connected by junctions where the junction P¹ is between antenna function 3-1 and filter function 3-2, where the junction P² is between filter function 3-2 and the amplifier function 3-3, where the junction P³ is between amplifier function 3-3 and filter function 3-4 and where the junction P⁴ is between filter function 3-4 and mixer function 3-5. In the embodiment of FIG. 1, junctions P², P³ and P⁴ correspond to physical ports of physical filter, amplifier, filter and mixer components. The antenna function 3-1 and the filter function 3-2 are integrated so that the P¹ junction parameters are integrated and hence not separately considered. The junction parameter P² is tuned for the combined antenna function 3-1 and the filter function 3-2 in an integrated filter and antenna component 3-1/2. The integrated filter and antenna functions in integrated component (filtenna) 3-1/2 are characterized by the junction properties at junction P² while ignoring and not tuning the parameters at P¹. In particular, the junction impedance or other parameters at P¹ are not tuned to standard values, such as a 50 ohm matching impedance. The parameters at P¹ are “ignored” and assume values dependent on the tuned values for parameters at P² In this manner, the antenna and filter (filtenna) functions of integrated component 3-1/2 avoid the losses and other detriments attendant to matching the P¹ junction to standard values. For example, the filter function includes one or more additional filter poles in the filtenna integrated component, due to the contribution of the antenna, that cannot exist when the internal junction (P¹ in FIG. 1) is matched to a standard value. In this manner, the antenna function provides a resonator function that combines with a resonator functions of the filter.

In FIG. 2, a k^{th} junction typical of the junctions P², P³ and P⁴ in FIG. 1 is shown and includes an incident wave a^{k} traveling toward a junction and a scattered wave b^{k} traveling away from the junction. As a consequence of Maxwell's equations, a linear relationship exists between b^{k} and a^{k}. In vector notation, this relationship is expressed as

b^{k}=S^{k}a^{k} (1)

where S^{k} is a scattering matrix parameter of size n-by-n at the junction formed of sᵢⱼ values where i,j vary from 1 to n for an n-port device. The sᵢⱼ for i=j, sᵢ₌ⱼ, is the reflection coefficient looking into port i and sᵢⱼ for i≠j, s_{i≠j}, is the transmission coefficient from port i to port j.

For a reciprocal junction, sᵢ₌ⱼ=S_{i≠j}, the matrix is symmetrical and therefore,

S^{k}=\overline{S^{k}} (2)

where \overline{S^{k}} is the transpose of S^{k}. The total power incident on the junction is proportional to |a^{k}|² and the total power reflected from the junction is proportional to |b^{k}|².

For the scattering properties of a single transmission line formed of single two-line input-to-output logical ports, and where reciprocity applies, the scattering matrix for each logical junction k is

$${S}^{k} = [ \begin{matrix}{s}_{11}^{k} & {s}_{12}^{k} \\ {s}_{21}^{k} & {s}_{22}^{k}\end{matrix} ] \qquad ( 3 )$$

with s^{k}₁₂=s^{k}₂₁. The insertion loss of the junction is the quantity −20log₁₀|s₁₂^{k}|.

For any junction k, the transmission matrix T^{k} is defined as follows:

$${T}^{k} = [ \begin{matrix}{t}_{11}^{k} & {t}_{12}^{k} \\ {t}_{21}^{k} & {t}_{22}^{k}\end{matrix} ] \qquad ( 4 )$$

The transmission matrix T^{k} is related to the scattering matrix S^{k} for any junction k as follows:

$$\begin{matrix}{s}_{11}^{k} = \frac{{t}_{21}^{k}}{{t}_{11}^{k}} & ( 5 ) \\ {s}_{12}^{k} = \frac{( {t}_{11}^{k} ) ( {t}_{22}^{k} ) - ( {t}_{12}^{k} ) ( {t}_{21}^{k} )}{{t}_{11}^{k}} & ( 6 ) \\ {s}_{21}^{k} = \frac{1}{{t}_{11}^{k}} & ( 7 ) \\ {s}_{22}^{k} = \frac{- {t}_{12}^{k}}{{t}_{11}^{k}} & ( 8 )\end{matrix}$$

In FIG. 3, a schematic representation of the connection of K junctions, of the type described in FIG. 2, are shown representing the RF front end of a communication. In FIG. 3, the logical junctions P¹, P², . . . , P^{k}, P^{(k+1)}, . . . , P^{K} represent the RF junctions of components in the RF front end of a communication device like that of FIG. 1. The “junction” P⁰ represents the parameters at the radiation interface and the “junction” P^{(K+1)} represents the parameters at the lower frequency interface, for example, from a mixer 3-5 to the base components 2₁ in FIG. 1.

Where a device, as in FIG. 3, is formed of components with junctions 1, 2, . . . , k, . . . , K, the total transmission matrix, T^{T}, for the entire device is given as follows:

T^{T}=[T^{k=1}][T^{k=2}], . . . , [T^{k}], . . . , [T^{k=K}] (9)

or

$${T}^{1} = {\prod }_{k = 1}^{K} {T}^{k} , \qquad ( 10 )$$

In Eq (9) and Eq (10), the total transmission matrix T^{T} is formed of the transmission values Tᵢⱼ for i and j equal to 1, 2 for a 2-port device as follows:

$${T}^{1} = [ \begin{matrix}{T}_{11} & {T}_{12} \\ {T}_{21} & {T}_{22}\end{matrix} ] \qquad ( 11 )$$

From Eq (11), the total scattering matrix S^{T} is formed of the scattering values Sᵢⱼ for i and j equal to 1, 2 for a 2-port device as follows:

$${S}^{T} = [ \begin{matrix}{S}_{11} & {S}_{12} \\ {S}_{21} & {S}_{22}\end{matrix} ] \qquad ( 12 )$$

The scattering values S₁₁, S₁₂, S₁₃ and S₁₄ are obtained from Eq (5), Eq (6), Eq (7) and Eq (8) letting Tᵢⱼ equal tᵢⱼ.

Equations (1) through (12) are for two-port junctions and employ 2-by-2 matrices. When junctions for three or more ports are employed, Equations (1) through (12) are expanded accordingly. For example, three-port junctions employ 3-by-3 matrices and n-port junctions employ n-by-n matrices for the Equations (1) through (12).

Using typical design practice, the scattering matrix for each junction of discrete components, such as amplifier 3-3, filter 3-4 and mixer 3-5 in FIG. 1, is determined using standard equipment such as the RAL HP-8720A network analyzer from Hewlett-Packard. With such equipment or other conventional design technique, the junction parameters of each of the discrete RF components in the front ends of communication devices are obtained.

Using typical design practice, the design of RF front-ends of communication devices optimizes each discrete component, such as amplifier 3-3, filter 3-4 and mixer 3-5 in FIG. 1, at each junction P², P³ and P⁴, with each junction tuned to a standard value such as 50 ohms impedance. The optimized discrete components, such as amplifier 3-3, filter 3-4 and mixer 3-5 in FIG. 1, are connected together to form the overall communication device. The device of the present invention, additionally optimizes the integrated antenna 3-1 and filter 3-2 front-end RF functions without internal tuning for the logical junction between the antenna 3-1 and filter 3-2 functions.

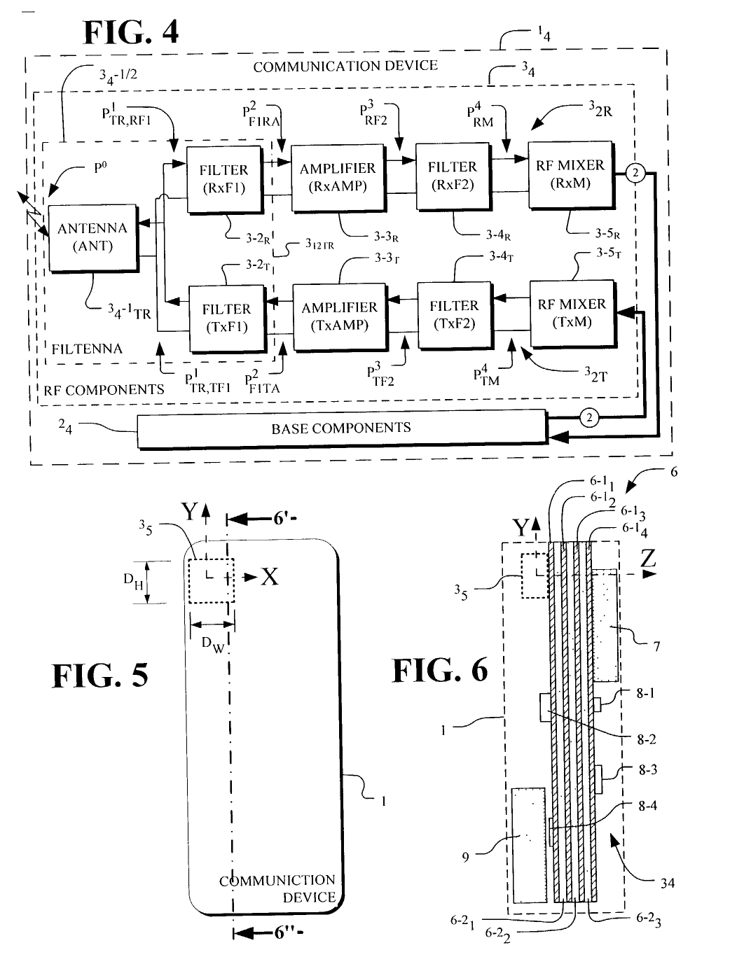

FIG. 4 depicts a schematic view of a small communication device 1₄, as one embodiment of the communication device 1₁ of FIG. 1, with RF front-end components 3₄ and base components 2₄. The RF components perform the RF front-end functions and have both a receive path 3_{2R} and a transmit path 3_{2T}. The receive path 3_{2R} includes an antenna function 3₄-1_{TR}, a filter function 3-2_{R}, an amplifier function 3-3_{R}, a filter function 3-4_{R} and a mixer function 3-5_{R}. The antenna function 3₄-1_{TR} is for converting between received radiation and electronic signals, the filter function 3-2_{R} is for limiting signals within an operating frequency band for the receive signals, the amplifier function 3-3_{R} is for boosting receive signal power, the filter function 3-4_{R} is for limiting signals within the operating frequency receive band, and the mixer function 3-5_{R} is for shifting frequencies between RF receive signals and lower frequencies.

The transmit path 3_{2R} includes a mixer function 3-5_{T}, a filter function 3-4_{T}, an amplifier function 3-3_{T}, and an antenna function 3-1_{TR}, a filter function 3-2_{T}, and an antenna function 3₄-1_{TR}. The mixer function 3-5_{T} is for shifting frequencies between lower frequencies and RF transmit signals, the filter function 3-4_{T} is for limiting signals within the operating frequency transmit band, the amplifier function 3-3_{T} is for boosting transmit signal power, the filter function 3-2_{T} is for limiting signals within operating frequency band for the transmit signals, and the antenna function 3₄-1_{TR} is for converting between electronic signals and the transmitted radiation.

In FIG. 4, the RF front-end functions are connected by junctions where the junctions when a discrete physical port may not exist are designated as “logical junctions”. The logical junction P¹_{TR,RF1} is between antenna function 3₄-1_{TR} and filter functions 3-2_{R}, the junction P²_{F1RA} is between filter function 3-2_{R} and the amplifier function 3-3_{R}, the junction P³_{RF2} is between amplifier function 3-3_{R} and filter function 3-4_{R} and the junction P⁴_{RM} is between filter function 3-4_{R} and mixer function 3-5_{R}. The logical junction P¹_{TR,TF1} is between antenna function 3₄-1_{TR} and filter functions 3-2₁, the junction P²_{F1TA} is between filter function 3-2_{T} and the amplifier function 3-3_{T}, the junction P³_{TT2} is between amplifier function 3-3_{T} and filter function 3-4_{T} and the junction P⁴_{TM} is between filter function 3-4_{T} and mixer function 3-5_{T}.

In the embodiment of FIG. 4, the junctions P²_{F1RA}, P³_{RF2} and P⁴_{RM} correspond to physical ports or physical amplifier 3-3_{R}, filter 3-4_{R} and mixer 3-5_{R} components and the junctions P⁴_{TM}, P³_{TF2} and P²_{F1TA} correspond to physical ports of physical mixer 3-5_{T}, filter 3-4_{T} and amplifier 3-3T components. The antenna function 3₄-1_{TR} and the filter functions 3-2_{R} and 3-2_{T} are integrated into a common integrated component, filtenna 3₄-1/2, so that the P¹_{TR,RF1} and P¹_{TR,TF1} logical junction parameters are integrated and not separately tuned. The junction parameters P²_{F1RA} and P²_{F1TA} are tuned for the combined antenna function 3₄-1_{TR} and the filter functions 3-2_{R} and 3-2_{T}. The integrated filter and antenna functions in FIG. 4, the filtenna component 3₄-1/2, are characterized by the junction properties at the two ports having parameters for junctions P²_{F1RA} and P²_{F1TA}. In particular, the junction impedance or other parameters which may exist at the P¹_{TR,RF1} and P¹_{TR,TF1} logical junctions are not tuned to provide standard values, such as a 50 ohm matching impedance, but are permitted to assume values dependent on the desired values for parameters junction at the P²_{F1RA} and P²_{F1TA} junctions.

In FIG. 4, to accomplish the tuning, the filtenna 3₄-1/2 is represented by a single scattering matrix which is a 3×3 matrix because the filtenna 3₄-1/2 has three ports, referenced by junctions P²_{F1RA} and P²_{F1TA} and the radiation interface junction P⁰. In this manner, the integrated antenna and filter functions avoid the losses and other detriments attendant to matching the P¹_{TR,RF1} and P¹_{TR,TF1} logical junctions to standard values. The need for standardizing between the antenna and filter functions is removed and design freedom is added to the integrated filtenna 3₄-1/2 whereby, for example, a pole in the antenna function is combined with poles in the filter functions to enhance the filter functions.

In FIG. 5, communication device 1 is a cell phone, pager or other similar communication device that can be used in close proximity to people. The communication device 1 includes an antenna area allocated for an antenna 3₅ which receives and/or transmits radio wave radiation for the communication device 1. In FIG. 5, the antenna area has a width D_{W} and a height D_{H}. A section line 6′-6″ extends from top to bottom of the communication device 1.

In FIG. 5, the antenna 3₅ is typically a compressed antenna that generally lies in an XYZ-volume having magnetic current in the Z-axis direction normal to the XY-plane of the drawing. Such antennas operate in cellular frequencies of the world including those of North America, South America, Europe, Asia and Australia. The cellular frequencies are used when the communication device is a mobile phone, PDA, portable computer, telemetering equipment or any other wireless device. The antennas operate to transmit and/or receive in mobile telephone frequency bands, for example, anywhere from 800 MHz to 2500 MHz.

In FIG. 6, the communication device 1 of FIG. 5 is shown in a schematic, cross-sectional, end view taken along the section line 6′-6″ of FIG. 5. In FIG. 6, a circuit board 6 includes, by way of example, an outer conducting layer 6-1₁, internal conducting layers 6-1₂ and 6-1₃, internal insulating layers 6-2₁, 6-2₂ and 6-2₃, and another outer conducting layer 6-1₄. In one example, the layer 6-1₁ is a ground plane and the layer 6-1₂ is a power supply plane. The printed circuit board 6 supports the electronic components associated with the communication device 1 including a display 7 and miscellaneous components 8-1, 8-2, 8-3 and 8-4 which are shown as typical. Communication device 1 also includes a battery 9. The antenna 3₅ is mounted to the printed circuit board 6 by solder or other convenient connection.

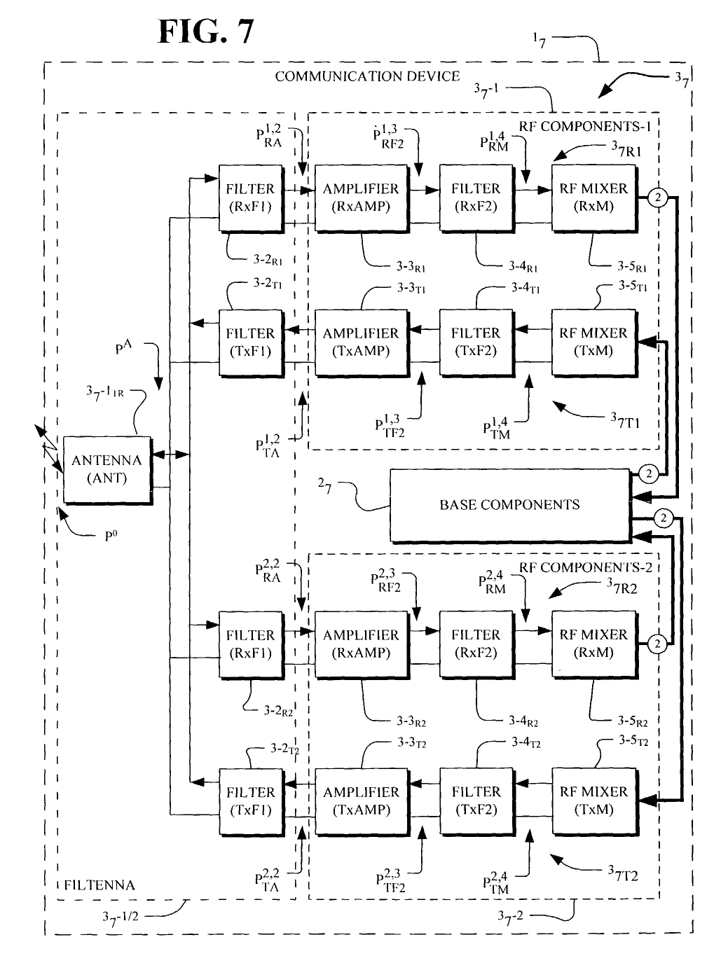

FIG. 7 depicts a schematic view of a small communication device 1₇, as another embodiment of the communication device 1₁ of FIG. 1, with base components 2₇ and RF front-end components 3₇ including front-end components 3₇-1, front-end components 3₇-2 and front-end components 3₇-1/2. The RF components 3₇ perform the RF front-end functions as described in connection with FIG. 1 for two different bands, Band 1 and Band 2. Both bands share the common filtenna component 3₇-1/2. Band 1 includes filtenna component 3₇-1/2 and front-end components 3₇-1. Band 2 includes filtenna component 3₇-1/2 and front-end components 3₇-2. Both Band 1 and Band 2 have a receive path and a transmit path.

For Band 1, a receive path 3^{7R1} and a transmit path 3_{7T1} are present. The receive path 3_{7R1} includes an antenna function 3₇-1_{1R}, a filter function 3-2_{R1}, an amplifier function 3-3_{R1}, a filter function 3-4_{R1} and a mixer function 3-5_{R1}. The antenna function 3₇-1_{TR} is for converting between radiated and electronic signals, the filter function 3-2_{R1} is for limiting signals within operating frequency band for the receive signals, the amplifier function 3-3_{R1} is for boosting receive signal power, the filter function 3-4_{R1} is for limiting signals within the operating frequency receive band, and the mixer function 3-5_{R1} is for shifting frequencies between RF receive signals and lower frequencies. For Band 1, the transmit path 3_{7T1} includes an antenna function 3₇-1_{TR}, a filter function 3-2_{T1}, an amplifier function 3-3^{T1}, a filter function 3-4_{T1} and a mixer function 3-5_{T1}. The antenna function 3₇-1_{TR} is for converting between radiated and electronic signals, the filter function 3-2_{T1} is for limiting signals within operating frequency band for the transmit signals, the amplifier function 3-3^{T1} is for boosting transmit signal power, the filter function 3-4_{T1} is for limiting signals within the operating frequency transmit band, and the mixer function 3-5_{T1} is for shifting frequencies between RF transmit signals and lower frequencies.

For Band 2, a receive path 3_{7R2} and a transmit path 3_{7T2} are present. The receive path 3_{7R1} includes an antenna function 3₇-1_{TR}, a filter function 3-2_{R2}, an amplifier function 3-3_{R2}, a filter function 3-4_{R2} and a mixer function 3-5_{R2}. The antenna function 3₇-1_{TR} is for converting between radiated and electronic signals, the filter function 3-2_{R2} is for limiting signals within operating frequency band for the receive signals, the amplifier function 3-3_{R2} is for boosting receive signal power, the filter function 3-4_{R2} is for limiting signals within the operating frequency receive band, and the mixer function 3-5_{R2} is for shifting frequencies between RF receive signals and lower frequencies. For Band 2, the transmit path 3_{T2} includes an antenna function 3₇-1_{TR}, a filter function 3-2_{T2}, an amplifier function 3-3_{T2}, a filter function 3-4_{T2} and a mixer function 35^{T2}. The antenna function 3₇-1_{TR} is for converting between radiated and electronic signals, the filter function 3-2_{T2} is for limiting signals within operating frequency band for the transmit signals, the amplifier function 3-3_{T2} is for boosting transmit signal power, the filter function 3-4_{T2} is for limiting signals within the operating frequency transmit band, and the mixer function 3-5_{T2} is for shifting frequencies between RF transmit signals and lower frequencies.

In FIG. 7, for Band 1 and Band 2, the front-end RF functions are connected by physical and logical junctions. The logical junctions P^{A} between antenna function 3₇-1_{TR} and filter functions 3-2_{R1}, 3-2_{T1} 3-2_{R2} and 3-2_{T2} are integrated and not separately tuned. The ports of the filtenna 3₇-1/2 are tuned with parameters for the junctions

$${P}_{RA}^{1 , 2} , {P}_{TA ,}^{1 , 2} {P}_{RA}^{2 , 2} , {R}_{TA}^{2 , 2} .$$

To accomplish the tuning, the filtenna 3₇-1/2 is represented by a scattering matrix, a 5×5 matrix because the filtenna 3₇-1/2 has five ports including

$${P}_{RA}^{1 , 2} , {P}_{TA ,}^{1 , 2} {P}_{RA}^{2 , 2} , {R}_{TA}^{2 , 2}$$

and P⁰.

For Band 1 in FIG. 7,

$${P}_{RF2}^{1 , 3}$$

is between amplifier function 3-3_{R1} and filter function 3-4_{R1};

$${P}_{RM}^{1 , 4}$$

is between filter function 3-4_{R1} and mixer function 3-5_{R1};

$${P}_{TF2}^{1 , 3}$$

is between amplifier function 3-3_{T1} and filter function 3-4^{T1}; and

$${P}_{TM}^{1 , 4}$$

is between filter function 3-4_{T1} and mixer function 3-5_{T1}.

For Band 2, the junction

$${P}_{RF2}^{2 , 3}$$

is between amplifier function 3-3_{R2} and filter function 3-4_{R2};

$${P}_{RM}^{2 , 4}$$

is between filter function 3-4_{R2} and mixer function 3-5R2;

$${P}_{TF2}^{2 , 3}$$

is between amplifier function 3-3_{T2} and filter function 3-4_{T2} and

$${P}_{TM}^{2 , 4}$$

is between filter function 3-4_{T2} and mixer function 3-5_{T2}.

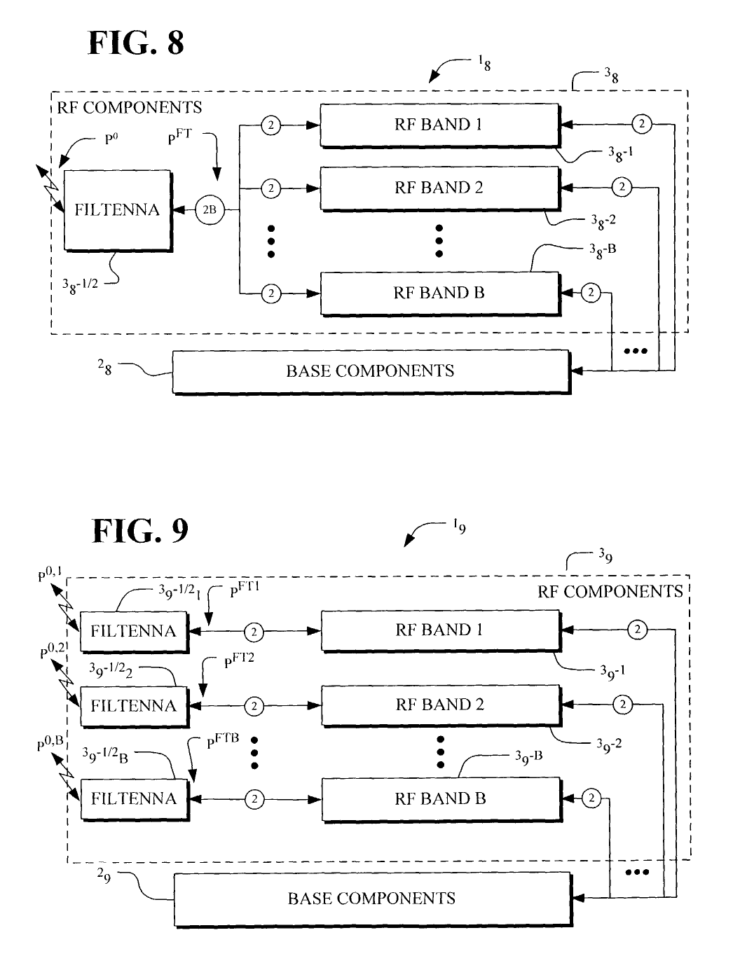

FIG. 8 depicts a schematic view of a multi-band small communication device 1₈ with RF front-end components 3₈ and base components 2₈. The RF components perform the RF front-end functions that include antenna, filter, amplifier and mixer functions.

In FIG. 8, the antenna function and the filter function are integrated in filtenna 3₈-1/2 so that the internal antenna and filter junction parameters are integrated. The parameters of junction P^{FT} for filtenna 3₈-1/2 are tuned for the integrated antenna and filter functions. The filtenna 3₈-1/2 connects to B RF bands 1, 2, . . . , B in front-end components 3₈-1, 3₈-2, . . . , 3₈-B, respectively, where each band includes a transmit and receive path. The filtenna 3₈-1/2 is an integrated component with [2(B)+1] ports that is characterized at junction P^{FT} by a [2(B)+1]-by-[2(B)+1] scattering matrix.

FIG. 9 depicts a schematic view of a multi-band small communication device 1₉ with RF front-end components 3₉ and base components 2₉. The RF components perform the RF front-end functions that include antenna, filter, amplifier and mixer functions.

In FIG. 9, the antenna function and the filter function are integrated in a plurality of filtennas 3₉-1/2₁, 3₉-1/2₂, . . . , 3₉-1/2_{B}, one for each of the bands 1, 2, . . . , B, respectively, where each band includes a transmit and receive path. The internal antenna and filter junction parameters are integrated. The junction parameters P^{FT1}, P^{FT2}, . . . , P^{FTB} of filtennas 3₉-1/2₁, 3₉-1/2₂, . . . , 3₉-1/2_{B} are each tuned for the combined antenna and filter functions of each band. The filtennas 3₉-1/2₁, 3₉-1/2₂, . . . , 3₉-1/2_{B} are each three-port components withe the radiation interface junctions P^{0,1}, P^{0,2}, . . . , P^{0,B} and the junctions P^{FT1}, P^{FT2}, . . . , P^{FTB}, respectively. The filtennas 3₉-1/2₁, 3₉-1/2₂, . . . , 3₉-1/2_{B} each connect to a corresponding one of the front-end components 3₉-1, 3₉-2, . . . , 3₉-B, respectively. According, the scattering matrix for each component is for a 3-port device and filtennas 3₉-1/2₁, 3₉-1/2₂, . . . , 3₉-1/2_{B} are tuned accordingly.

While the invention has been particularly shown and described with reference to preferred embodiments thereof it will be understood by those skilled in the art that various changes in form and details may be made therein without departing from the scope of the invention.

1. (Original) An RF component for an RF front end of a communication device where the RF front end includes an antenna function for converting between radiated and electronic signals, includes a filter function for limiting the electronic signals within operating frequency bands of the communication device, an amplifier function for amplifying the electronic signals and a mixer function for shifting the electronic signals between RF and lower frequencies, said functions connected at junctions in said RF front end to enable processing of the electronic signals,
the improvement characterized by said RF component integrating said antenna function and said filter function forming a filtenna characterized by integrated junction parameters for a combination of the antenna function and the filter function.

2. (Original) The RF component of claim 1 further characterized in that the antenna function provides an antenna resonator that combines with a filter resonator of the filter function.

3. (Original) The RF component of claim 2 wherein in the antenna function provides a plurality of antenna resonators that combine with a filter resonator.

4. (Original) The RF component of claim 1 wherein said filtenna is a three-port device.

5. (Original) The RF component of claim 4 wherein said filtenna includes a transmit signal port and a receive signal port.

6. (Original) The RF component of claim 1 having a plurality of ports where each port is optimized for a different frequency band.

7. (Original) The RF component of claim 6 wherein each frequency band includes a transmit signal band and a receive signal band.

8. (Original) The RF component of claim 1 wherein said communication device is a multiband device and wherein said filtenna includes a transmit signal port and a receive signal port for each band.

9. (Original) The RF component of claim 1 wherein said communication device is a multiband device having a plurality of bands and wherein a plurality of filtennas are provided, one for each of said bands.

10. (Original) The RF component of claim 9 wherein each of said filtennas includes a transmit signal port and a receive signal port.

11. (Original) The RF component of claim 1 wherein said communication device is a mobile telephone.
